(19) United States
(12) Patent Application Publication
(10) Pub. No.: US 2014/0304080 A1
(43) Pub. Date: Oct. 9, 2014

(54) SYSTEMS AND METHODS FOR MOBILE ON-SITE SERVICE AND ADVERTISING

(71) Applicant: Ugur Yilmaz, Littleton, MA (US)

(72) Inventor: Ugur Yilmaz, Littleton, MA (US)

(73) Assignee: Lube2Go LLC, Littleton, MA (US)

(21) Appl. No.: 14/122,570

(22) PCT Filed: May 29, 2012
(86) PCT No.: PCT/US2012/039833

§ 371 Date: Mar. 25, 2014

Related U.S. Application Data
(60) Provisional application No. 61/491,284, filed on May 30, 2011.

(51) Int. Cl. G06Q 30/02; G06Q 10/00

(52) U.S. Cl. CPC G06Q 30/0265; G06Q 30/0266; G06Q 10/20
USPC 705/14.63; 705/14.62

(57) ABSTRACT

A method and system for providing advertisements on a vehicle. The vehicle is adapted to provide one or more services for a first entity. A self-advertisement is displayed on the vehicle advertising the first entity, the one or more services provided by the vehicle, or one or more additional services provided by the first entity. While displaying the self-advertisement, a third-party advertisement can be presented on an electronic display system disposed on one or more exterior walls of the vehicle. The third-party advertisement can advertise information relating to a second entity that is unaffiliated with the first entity. The one or more services provided by the vehicle for the first entity can be different from advertisement services. The one or more services provided by the first vehicle can be on-site automotive maintenance services, such as on-site automotive oil changes, on-site automotive steam washes, or both.

### RELATED APPLICATIONS

This application claims priority to, and the benefit of, co-pending U.S. Provisional Application No. 61/491,284, filed May 30, 2011, for all subject matter common to both applications. The disclosure of said provisional application is hereby incorporated by reference in its entirety.

### FIELD OF THE INVENTION

The present invention relates to mobile advertisement systems and methods. More particularly, the present invention provides a vehicle adapted to present one or more third-party advertisements in conjunction with one or more self-advertisements.

### BACKGROUND OF THE INVENTION

Mobile advertising is a popular and effective form of advertisement for many companies. However, there are aspects of existing mobile advertising that can be considered environmentally and ecologically unfriendly. Existing mobile advertising is achieved by placing one or more advertisements on a billboard truck and driving the billboard truck around a particular designated location for a particular designated amount of time. Such mobile advertisement is achieved at the expense of pollutants and automobile emissions, which have detrimental effects on the surrounding environment.

### SUMMARY

There is a need for systems and methods for presenting advertisements in a more environmentally friendly manner. The present invention is directed toward solutions to address this and other needs, in addition to having other desirable characteristics that will be appreciated by one of skill in the art upon reading the present specification.

In accordance with an example embodiment of the present invention, a method of displaying an advertisement in provided. The method can include displaying, on a vehicle adapted to provide one or more services for a first entity. The first advertisement can be an advertisement for one or more of the first entity, the one or more services provided by the vehicle, or one or more additional services provided by the first entity. While displaying the first advertisement on the vehicle, a second advertisement can be displayed on an electronic display system disposed at least partially on one or more exterior walls of the vehicle. The second advertisement can display information relating to a second entity that is unaffiliated with the first entity.

In accordance with aspects of the present invention, the one or more services provided by the vehicle for the first entity can be different from (e.g., and unrelated to) advertisement services. The second entity can be associated with a location of the vehicle. The second advertisement can be displayed while the vehicle is performing the one or more services. The second advertisement can be displayed while the vehicle is in transit to or from one or more locations for performing the one or more services. A route or territory covered by the vehicle can be determined by the one or more services being provided by the vehicle and is not determined by the second entity or based on the second advertisement. The one or more services provided by the vehicle can include one or more on-site automotive maintenance services. The vehicle can contain automotive maintenance equipment for performing one or more on-site automotive maintenance services. The one or more on-site automotive maintenance services can include an oil change, a steam wash, or both.

In accordance with aspects of the present invention, the electronic display system can include one or more electronic mobile billboards each disposed on one or more exterior walls of the vehicle. The electronic display system can include one or more back-lit displays. Payment for the second advertisement can include one or more gift certificates administered to one or more customers of the one or more services provided by the vehicle. The vehicle can include an automobile (e.g., a truck). The first advertisement can be displayed on the electronic display system, on an exterior wall of the vehicle, or both. A plurality of third-party advertisements can be displayed on the electronic display system, and each of the third-party advertisements can be associated with an additional entity unaffiliated with the first entity.

In accordance with an example embodiment of the present invention, a mobile advertisement system includes a vehicle having one or more exterior walls and an interior. The vehicle can be adapted to provide one or more services for a first entity. An electronic display system can be disposed at least partially on at least one of the one or more exterior walls of the vehicle. Presented on at least one of the one or more exterior walls, the electronic display system, or both can be a first advertisement. The first advertisement can advertise one or more of the first entity, the one or more services provided by the vehicle, or one or more additional services provided by the first entity. A second advertisement can be displayed on the electronic display system. The second advertisement can display information relating to a second entity that is unaffiliated with the first entity.

In accordance with aspects of the present invention, automotive maintenance equipment can be disposed in the interior of the vehicle. A fluid receptacle can be disposed on a roof of the vehicle adapted to catch rain water. The automotive maintenance equipment can include automotive steam wash equipment. A drain can be disposed in the fluid receptacle and a pipe can lead from the drain to one or more fluid vessels disposed in the interior of the vehicle.

In accordance with aspects of the present invention, automotive oil-change equipment and automotive steam wash equipment can be disposed in the interior of the vehicle. One or more containers can be disposed in the interior of the vehicle for storing used motor oil collected from one or more oil changes. The one or more services provided by the vehicle for the first entity can be different from (e.g., unrelated to) advertisement services. The second entity can be associated with a location (e.g., a route) of the vehicle. The second advertisement can be displayed while the vehicle is performing the one or more services or can be displayed while the vehicle is in transit to or from one or more locations for performing the one or more services. A route or territory covered by the vehicle can be determined by the one or more services being provided by the vehicle and is not determined by the second entity or based on the second advertisement.

In accordance with aspects of the present invention, the one or more services provided by the vehicle can include one or more on-site automotive maintenance services. The electronic display system can include one or more electronic mobile billboards each disposed on at least one of the one or more exterior walls of the vehicle. The electronic display system can include one or more back-lit displays. The vehicle can include an automobile. The electronic display system can be configured to display a plurality of third-party advertisements each associated with an additional entity that is unaffiliated with the first entity.

In accordance with an example embodiment of the present invention, a vehicle can be provided having one or more exterior walls and an interior. The vehicle can be adapted to provide one or more services for a first entity. The vehicle can include an electronic display system disposed at least partially on at least one of the one or more exterior walls of the vehicle. A first advertisement can be presented on at least one of the one or more exterior walls, the electronic display system, or both. The first advertisement can advertise one or more of the first entity, the one or more services provided by the vehicle, or one or more additional services provided by the first entity. The electronic display system can be caused to display a second advertisement advertising information relating to a second entity that is unaffiliated with the first entity.

In accordance with aspects of the present invention, the electronic display system can display a plurality of additional third-party advertisements each associated with an additional entity that is unaffiliated with the first entity. Rain water can be caught in a fluid receptacle disposed on a roof of the vehicle. The rain water can be passed through a drain in the fluid receptacle and through a pipe coupling the drain to one or more water vessels disposed in the interior of the vehicle. The rain water can be heated in the one or more water vessels to produce steam. The steam produced from heating the rain water can be used to perform a steam wash with automotive steam wash equipment. The step of heating the rain water can include comprises producing heat by burning used motor oil collected from one or more oil changes.

In accordance with aspects of the present invention, automotive maintenance equipment can be provided and disposed in the interior of the vehicle. The automotive maintenance equipment can include automotive oil-change equipment and automotive steam wash equipment. Used motor oil collected from one or more oil changes can be stored in one or more containers. Heat can be produced by burning the used motor oil stored in the one or more containers. Steam can be produced by transferring the heat to one or more fluid vessels containing water. A steam wash can be performed using the produced steam.

In accordance with an example embodiment of the present invention, a third-party advertisement can be displayed on an electronic display system disposed at least partially on one or more exterior walls of a vehicle. The vehicle can be adapted to provide one or more on-site automotive maintenance services. The third-party advertisement can be provided by a non-related entity to the vehicle. While displaying the third-party advertisement on the electronic display system, an advertisement can be displayed on the vehicle for the one or more on-site automotive maintenance services.

In accordance with an example embodiment of the present invention, a mobile advertisement and service system includes a vehicle having an interior and one or more exterior walls. Automotive maintenance equipment can be disposed in the interior of the vehicle and adapted for one or more on-site automotive maintenance services. An electronic display system can be disposed at least partially on at least one of the one or more exterior walls of the vehicle. An advertisement for the one or more on-site automotive maintenance services can be presented on at least one of the one or more exterior walls, the electronic display system, or both. The electronic display system can be configured to display a third-party advertisement. The third-party can be a non-related entity to a party providing the one or more on-site automotive maintenance services.

### BRIEF DESCRIPTION OF THE FIGURES

These and other characteristics of the present invention will be more fully understood by reference to the following detailed description in conjunction with the attached drawings, in which:

FIG. 1 is a perspective view of a vehicle for displaying advertisements according to an example embodiment of the present invention;

FIG. 2 is a perspective view of the vehicle of FIG. 1 with the interior of the vehicle shown, according to aspects of the present invention;

FIG. 3 is a perspective view of the vehicle of FIG. 1 with the interior shown and with one or more containers disposed in the interior of the vehicle, according to aspects of the present invention;

FIGS. 4A through 4C are a perspective view, a top view, and a perspective view showing an interior, respectively, of the vehicle of FIG. 1 further including a system for capturing and storing rain water, according to aspects of the present invention;

FIG. 5 is a flow chart of a method for displaying advertisements on a vehicle according to an example embodiment of the present invention;

FIG. 6 is a flow chart of a method for collecting and storing rain water for use in a steam wash according to aspects of the present invention; and

FIG. 7 is a flow chart of a method for heating water for use in a steam wash by burning used motor oil collected from one or more oil changes, according to to aspects of the present invention.

### DETAILED DESCRIPTION

An illustrative embodiment of the present invention relates to a method and system for providing advertisements on a vehicle. A first advertisement is displayed on the vehicle. The vehicle is adapted to provide one or more services for a first entity. The first advertisement displayed on the first vehicle can advertise the first entity, the one or more services provided by the vehicle, one or more additional services provided by the first entity, or combinations thereof. While displaying the first advertisement on the vehicle, a second advertisement can be presented on an electronic display system disposed on one or more exterior walls of the vehicle. The second advertisement can advertise information relating to a second entity that is unaffiliated with the first entity. As used herein, “unaffiliated” generally refers to business independence between two entities. Stated differently, two entities are “unaffiliated” if the actions of one of the companies are not controlled by the other company.

In the illustrative embodiment, the one or more services provided by the vehicle for the first entity are not advertisement services. Rather, in the illustrative embodiment, the one or more services provided by the first vehicle are on-site automotive maintenance services. For example, the on-site automotive maintenance services can include on-site automotive oil changes, on-site automotive steam washes (e.g., interior steam washes, exterior steam washes, engine steam washes, etc.), or both.

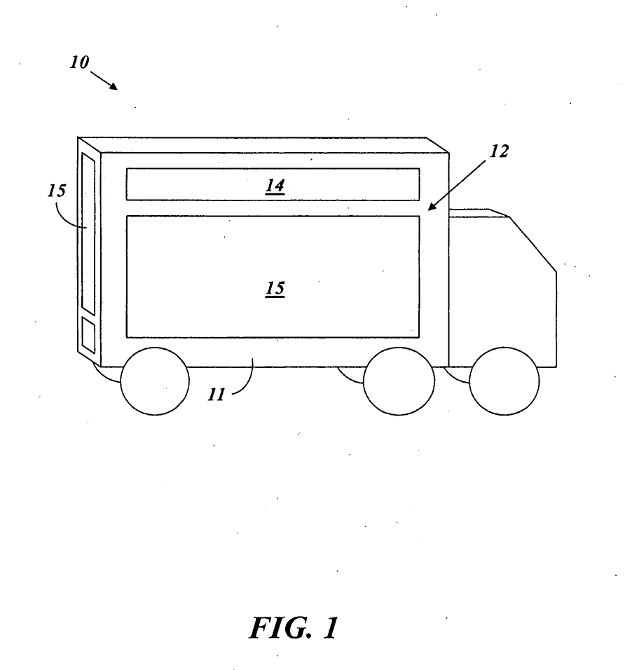

FIGS. 1 through 7, wherein like parts are designated by like reference numerals throughout, illustrate example embodiments of displaying advertisements on a vehicle, e.g., which is adapted to provide one or more on-site automotive maintenance services. Although the present invention will be described with reference to the example embodiments illustrated in the figures, it should be understood that many alternative forms can embody the present invention. One of skill in the art will appreciate different ways to alter the parameters of the embodiments disclosed, such as the size, shape, or type of elements or materials, in a manner still in keeping with the spirit and scope of the present invention.

FIG. 1 depicts a perspective view of a vehicle 10 (e.g., a truck) for delivering advertisements, in accordance with an example embodiment of the present invention. The vehicle 10 is adapted to provide one or more services for a first entity. In illustrative embodiments, the one or more services provided by the vehicle 10 for the first entity are not advertisement services. For example, the one or more services provided by the vehicle 10 can include any number of different services (e.g., catering services, delivery services, electrical or plumbing services, and any other types of services involving vehicle transportation). For purposes of illustration, the vehicle 10 will be described herein with reference to an example embodiment implemented for one or more on-site automotive services. The one or more on-site automotive services can include on-site automotive oil changes, on-site automotive steam washes (e.g., exterior steam washes, interior steam washes, engine steam washes, and the like). However, the vehicle 10 alternatively or additionally may be adapted for any other suitable service(s) different from advertisement services. All such alternatives and modifications are contemplated within the scope of the present invention.

The vehicle 10 includes one or more exterior walls 11. Disposed on the exterior walls 11 can be an electronic display system 12 that is configured to present one or more advertisements (e.g., one or more “third-party advertisements,” one or more “self-advertisements” for the first entity, or both). A “third-party advertisement,” as used herein, generally refers to any advertisement advertising information for some second entity which is unaffiliated with the first entity. A “self-advertisement” for the first entity generally refers to any advertisement advertising the first entity, the one or more services provided by the vehicle 10 for (e.g., on behalf of) the first entity, one or more additional products/services provided by the first entity, or any combination thereof. The electronic display system 12 can include one or more electronic mobile billboards 15 (e.g., scrolling type) each disposed on one or more of the exterior walls 11 of the vehicle 10. For example, the electronic mobile billboards 15 can be back-lit electronic mobile billboards. In addition to advertisements presented on the electronic display system 12, one or more fixed advertisements 14 (e.g., printed or painted advertisements, or any other suitable fixed, non-electronic advertisements) can also be disposed on the exterior walls 11 of the vehicle 10.

In illustrative embodiments, the electronic display system 12 is specifically configured to present, third-party advertisements for entities unaffiliated with the first entity, and the fixed advertisements 14 include “self-advertisements” for the first entity (i.e., advertisements advertising the first entity, the one or more services provided by the vehicle 10 for the first entity, one or more additional products/services provided by the first entity, or any combination thereof). Accordingly, in illustrative embodiments, the vehicle 10 includes both third-party advertisements and self-advertisements disposed on its exterior walls 11.

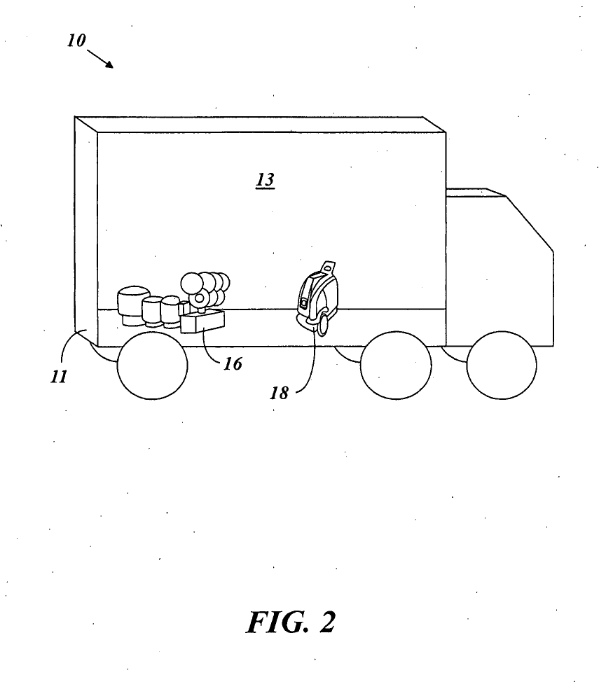

The one or more services provided by the vehicle 10 include one or more on-site automotive maintenance equipment. For example, FIG. 2 depicts a perspective view of the vehicle 10 with an interior 13 of the vehicle shown, in accordance with an example embodiment of the present invention. As depicted in FIG. 2, disposed within the interior 13 of the vehicle 10 is on-site automotive maintenance equipment. The on-site automotive maintenance equipment can include on-site automotive oil change equipment 16 (e.g., pumps, as depicted) and/or on-site automotive steam wash equipment 18. Alternatively or additionally, the on-site automotive oil change equipment 16 can include one or more ramps, lifts, and the like adapted to provide underside access of a car to a maintenance worker, thereby allowing the maintenance worker to change the oil of the car from below, as would be appreciated by one of skill in the art upon.

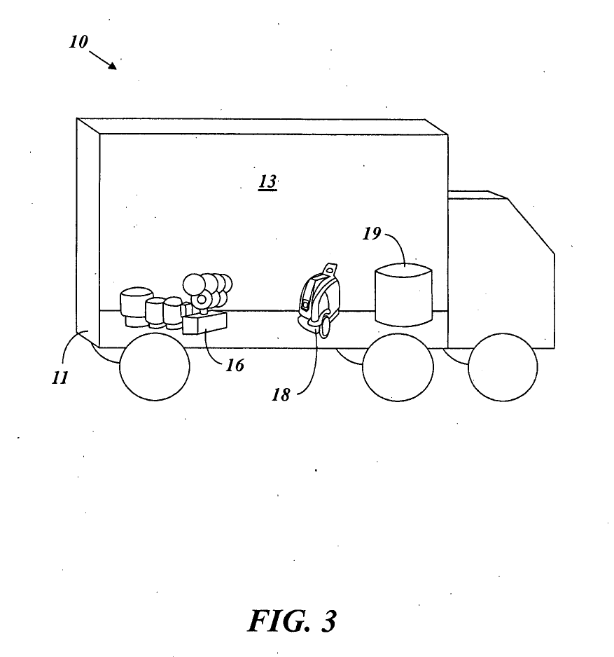

Additional features also can be included to allow the vehicle 10 to achieve greater efficiency in providing the one or more services (e.g., the one or more on-site automotive maintenance services). For example, FIG. 3 depicts a perspective view of the vehicle 10 with the interior 13 shown. In the example embodiment of FIG. 3, the vehicle 10 further includes one or more containers 19 disposed in the interior 13 and suitable for storing used motor oil collected by the on-site automotive oil change equipment 16 while performing one or more oil changes. For example, used motor oil that is stored in the one or more containers 19 can be later utilized (e.g., combusted) to generate heat for producing steam to be utilized by the on-site automotive steam wash equipment 18 for performing in a steam wash, as described in greater detail herein.

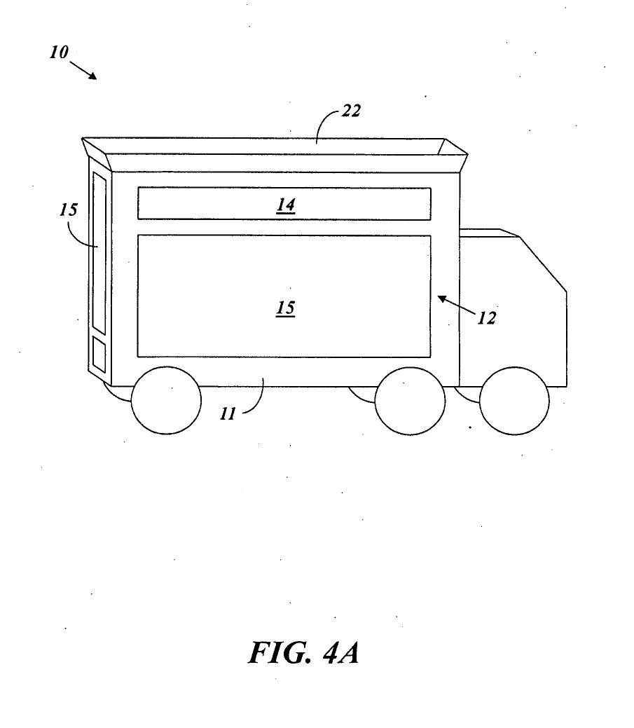

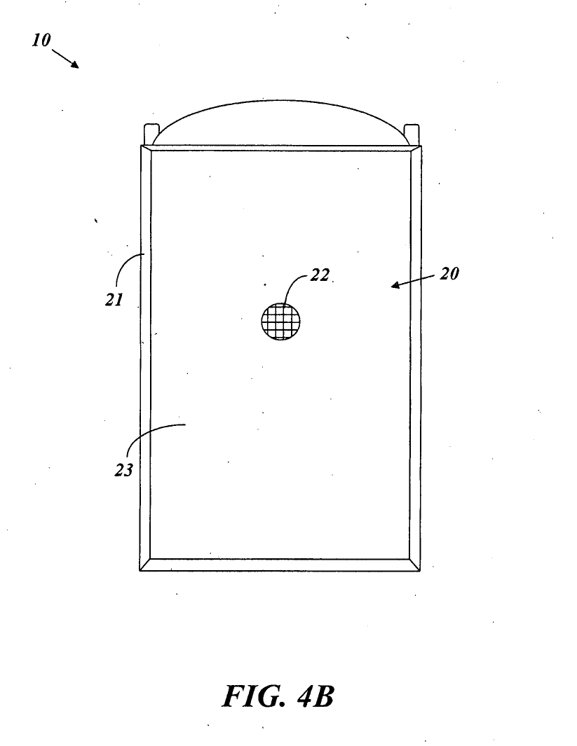

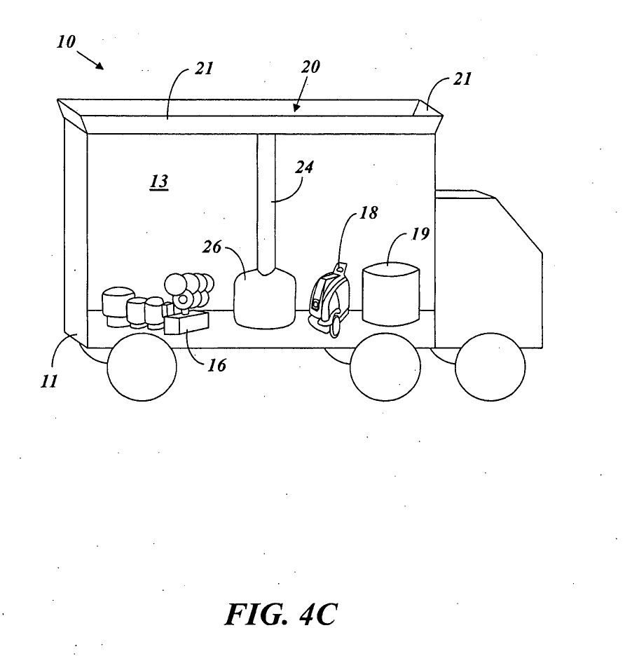

As another example, FIG. 4A depicts a perspective view of the vehicle 10 further including a fluid receptacle 20 adapted to catch rain water, in accordance with an example embodiment of the present invention. FIG. 4B further depicts the vehicle 10 of FIG. 4A from a top view. FIG. 4C further depicts a side view of the vehicle 10 of FIG. 4A with the interior 13 shown. As depicted in the example embodiment of FIGS. 4A through 4C, the fluid receptacle 20 can include a plurality of side walls 21 leading to a base surface 23. The side walls 21 can be sloped in a manner suitable for directing rain water toward the base surface 23. The base surface 23 additionally can be sloped in a manner suitable for directing rain water toward one or more drains 22. In this way, rain water that falls into the fluid receptacle 20 is caused to enter the one or more drains 22. As depicted in FIG. 4C, the drain 22 can lead to a pipe 24 disposed in the interior 13 of the vehicle 10. The pipe 24 can terminate at a reservoir 26 suitable for storing the rain water captured by the fluid receptacle 20. As described in greater detail herein, the rain water captured by the fluid receptacle 20 and stored in the reservoir 26 can be later used to perform steam washes. The reservoir 26 thus can be coupled to the on-site automotive steam wash equipment 18. Optionally, the captured rain water can undergo one or more filtration processes, e.g., prior to being utilized by the on-site automotive steam wash equipment 18 in a steam wash.

In operation, the on-site automotive steam wash equipment 18 can be configured to detect a water level in the reservoir 26 and utilize water stored therein only if the detected water level meets a threshold level. The on-site automotive steam wash equipment 18 further can be coupled to an additional reservoir (not shown) and can be adapted to utilize water stored in the additional reservoir (not shown) in instances where the on-site automotive steam wash equipment 18 determines that there is not a sufficient amount of rain water in the reservoir 26 to perform some or all of the steam wash. For example, the on-site automotive steam wash equipment 18 can be calibrated to draw water from the reservoir 26 when the on-site automotive steam wash equipment 18 detects that water is present in the reservoir 26, and further can be calibrated to draw water from the additional reservoir (not shown) when the on-site automotive steam wash equipment 18 detects that water is not present in the reservoir 26. Furthermore, the vehicle 10 can be adapted in such a way that when the reservoir 26 is full of rain water and can store no additional rain water, excess rain water entering through the drain 22 is unloaded from the vehicle 10 (e.g., through one or more gutters, spouts, etc.). Alternatively, the drain 22 and the fluid receptacle 20 can be adapted such that when the reservoir 26 is full, the drain 22 shuts and excess water caught by the fluid receptacle 20 is caused to exit the fluid receptacle 20, e.g., through one or more gutters, spouts, etc.

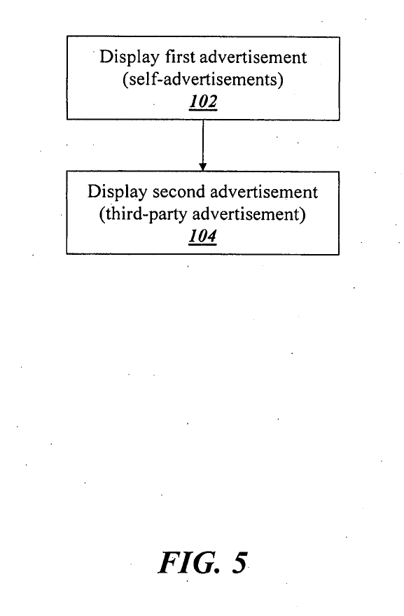

Reference is now made to FIG. 5, which depicts a flow chart of a method for displaying advertisements on the vehicle 10, in accordance with an example embodiment of the present invention. As illustrated, a first advertisement can be displayed on the vehicle 10 (step 102). The first advertisement can be a self-advertisement (i.e., which advertises the first entity, the one or more services provided by the vehicle 10 for the first entity, one or more additional services/products provided by the first entity, or combinations thereof). For example, the first advertisement can displayed as one of the fixed advertisements 14 disposed on one or more of the exterior walls 11 of the vehicle 10. Simultaneously with step 102, a third-party advertisement can be displayed on the vehicle 10 (step 104), e.g., can be displayed on the electronic display system 12. As described previously herein, in illustrative embodiments the third-party advertisements are presented on the electronic display system 12.

Optionally, payment for the third-party advertisements can provided by the unaffiliated entity in the form of gift certificates, which can specifically designate (as the recipients) and/or can be administered to one or more customers of the one or more services provided by the vehicle 10. For example, a pizza restaurant can be enabled to pay for its third-party advertisements on the vehicle 10 by providing a plurality of gift certificates to its local restaurant chains. The plurality of gift certificates to the local restaurant chains then can be distributed to the first entity's customers receiving the on-site automotive maintenance services.

In accordance with illustrative embodiments of the present invention, the one or more services provided by the vehicle 10 for the first entity are not advertisement services. In further illustrative embodiments, the one or more services provided by the vehicle 10 are not topically pertinent to the third-party advertisements presented on the vehicle 10. For example, the one or more services provided by the vehicle 10 can be on-site automotive maintenance services. The third-party advertisement(s) being presented on the electronic display system 12 at any given moment can be selected based on a location of the vehicle 10 (e.g., a current location, a future location or a route, etc.). For example, if the vehicle 10 is currently located in Boston, Mass. then the third-party advertisements presented on the electronic display system 12 can include (e.g., and be limited to) third-party advertisements for companies located specifically in Boston, Mass. The third-party advertisements can be presented while the vehicle 10 is performing the one or more services (e.g., at on-site locations where the one or more on-site automotive maintenance services are performed). Alternatively or additionally, the third-party advertisements can be presented while the vehicle 10 is in transit to or from one or more locations (e.g., on-site locations) where the one or more services (e.g., on-site automotive maintenance services) are performed. In embodiments where third-party advertisements are displayed while the vehicle 10 is in transit, the route or territory traveled by the vehicle 10 can be determined based exclusively on the locations that must be visited to perform the one or more services (e.g., on-site automotive maintenance services). Stated differently, in such illustrative embodiments of the present invention, the route or territory traveled by the vehicle 10 is not determined by the unaffiliated third-party entities, and is not determined based on the particular third-party advertisements being presented on the electronic display system 12.

Accordingly, the vehicle 10 is adapted to present advertisements on the electronic display system 12 in an environmentally friendly manner as compared to existing mobile advertising systems. Mobile advertising is achieved by the vehicle 10 as the vehicle 10 travels along routes that it otherwise must travel to perform the one or more unrelated services (e.g., the on-site automotive maintenance services).

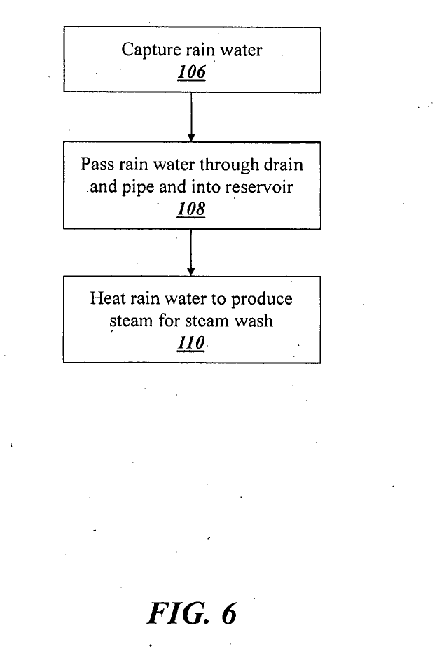

Reference is now made to FIG. 6, which depicts a flow chart of a method for performing a steam wash in accordance with an example embodiment of the present invention. As depicted, the fluid receptacle 20 can capture rain water (step 106), e.g., as the vehicle 10 is in transit between one or more locations where services are provided, while the vehicle 10 is providing the one or more services, etc. The rain water can be passed through the drain 22 and through the pipe 24 leading to the reservoir 26 (step 108). In this way, rain water can be stored in the reservoir 26. Subsequently, the captured rain water can be heated to produce steam (step 110) for use in a steam wash.

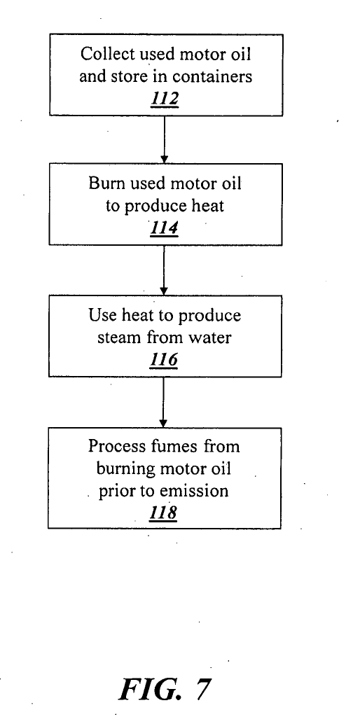

FIG. 7 depicts a flow chart of a method for heating water (e.g., for heating the stored rain water in step 110) to produce steam, in accordance with an example embodiment of the present invention. As illustrated, used motor oil can be collected by the on-site automotive oil change equipment 16 during oil changes and stored in the containers 19 (step 112). At the time of steam wash, the used motor oil can be burned to produce heat (step 114). The heat can be used to produce steam from water (step 116), e.g., the rain water collected from step 108. In this way, steam can be produced by burning used motor oil for use in a steam wash. Additionally, prior to emitting fumes produced by burning the motor oil, the resulting fumes can be processed (step 118), e.g., can be diluted, filtered, converted, or otherwise processed into an environmentally safe or safer waste product.

Numerous modifications and alternative embodiments of the present invention will be apparent to those skilled in the art in view of the foregoing description. Accordingly, this description is to be construed as illustrative only and is for the purpose of teaching those skilled in the art the best mode for carrying out the present invention. Details of the structure may vary substantially without departing from the spirit of the present invention, and exclusive use of all modifications that come within the scope of the appended claims is reserved. It is intended that the present invention be limited only to the extent required by the appended claims and the applicable rules of law.

It is also to be understood that the following claims are to cover all generic and specific features of the invention described herein, and all statements of the scope of the invention which, as a matter of language, might be said to fall therebetween.

1. A method of displaying an advertisement, the method comprising:
displaying, on a vehicle adapted to provide one or more services for a first entity, a first advertisement for one or more of the first entity, the one or more services provided by the vehicle, or one or more additional services provided by the first entity; and
while displaying the first advertisement on the vehicle, displaying a second advertisement on an electronic display system disposed at least partially on one or more exterior walls of the vehicle, the second advertisement displaying information relating to a second entity that is unaffiliated with the first entity.

2. The method of claim 1, wherein the one or more services provided by the vehicle for the first entity are not advertisement services.

3. The method of claim 1, wherein the second entity is associated with a location of the vehicle.

4. The method of claim 1, wherein the second advertisement is displayed while the vehicle is performing the one or more services.

5. The method of claim 1, wherein the second advertisement is displayed while the vehicle is in transit to or from one or more locations for performing the one or more services.

6. The method of claim 1, wherein a route or territory covered by the vehicle is determined by the one or more services being provided by the vehicle and is not determined by the second entity or based on the second advertisement.

7. The method of claim I, wherein the one or more services provided by the vehicle comprise one or more on-site automotive maintenance services.

8-10. (canceled)

11. The method of claim 1, wherein payment for the second advertisement comprises one or more gift certificates administered to one or more customers of the one or more services provided by the vehicle.

12. (canceled)

13. The method of claim 1, wherein the first advertisement is displayed on the electronic display system, on an exterior wall of the vehicle, or both.

14. The method of claim 1, further comprising displaying a plurality of third-party advertisements on the electronic display system, each of the third-party advertisements being associated with an additional entity unaffiliated with the first entity.

15. A mobile advertisement system, comprising:
a vehicle having one or more exterior walls and an interior, the vehicle adapted to provide one or more services for a first entity;
an electronic display system disposed at least partially on at least one of the one or more exterior walls of the vehicle;
a first advertisement for one or more of the first entity, the one or more services provided by the vehicle, or one or more additional services provided by the first entity, the first advertisement presented on at least one of the one or more exterior walls, the electronic display system, or both; and
a second advertisement displayed on the electronic display system, the second advertisement displaying information relating to a second entity that is unaffiliated with the first entity.

16. The system of claim 15, further comprising automotive maintenance equipment disposed in the interior of the vehicle and a fluid receptacle disposed on a roof of the vehicle adapted to catch rain water, wherein the automotive maintenance equipment comprises automotive steam wash equipment.

17. The system of claim 16, further comprising a drain disposed in the fluid receptacle and a pipe leading from the drain to one or more fluid vessels disposed in the interior of the vehicle.

18. The system of claim 15, further comprising:
automotive oil-change equipment and automotive steam wash equipment disposed in the interior of the vehicle; and
one or more containers disposed in the interior of the vehicle for storing used motor oil collected from one or more oil changes.

19. (canceled)

20. The system of claim 15, wherein the second entity is associated with a location of the vehicle.

21. The system of claim 15, wherein the second advertisement is displayed while the vehicle is performing the one or more services or is displayed while the vehicle is in transit to or from one or more locations for performing the one or more services.

22. The system of claim 15, wherein a route or territory covered by the vehicle is determined by the one or more services being provided by the vehicle and is not determined by the second entity or based on the second advertisement.

23. The system of claim 15, wherein the one or more services provided by the vehicle comprise one or more on-site automotive maintenance services.

24. The system of claim 15, wherein the electronic display system comprises one or more electronic mobile billboards each disposed on at least one of the one or more exterior walls of the vehicle.

25-26. (canceled)

27. The system of claim 15, wherein the electronic display system is configured to display a plurality of third-party advertisements each associated with an additional entity that is unaffiliated with the first entity.

28-38. (canceled)
